(19) United States
(12) Patent Application Publication
(10) Pub. No.: US 2024/0152309 A1
(43) Pub. Date: May 9, 2024

(54) DISPLAY CONTROLLER FOR A DISPLAY WALL

(71) Applicant: Mo-Sys Engineering Limited, London (GB)

(72) Inventors: Michael Paul Alexander Geissler, London (GB); Martin Peter Parsley, London (GB)

(73) Assignee: Mo-Sys Engineering Limited, London, OT (GB)

(21) Appl. No.: 18/549,062

(22) PCT Filed: Mar. 4, 2022
(86) PCT No.: PCT/GB2022/050582

§ 371 Date: Sep. 5, 2023

(30) Foreign Application Priority Data
Mar. 4, 2021 (GB) 2103060.6

(51) Int. Cl. G06F 3/14; G06F 3/147; G06T 7/73; G09G 3/32; G09G 5/12

(52) U.S. Cl. CPC G06F 3/1446; G06F 3/147; G06T 7/73; G09G 3/32; G09G 5/12; G06T 2207/10016; G06T 2207/30244; H04N 5/2224

(57) ABSTRACT

A display controller configured to cause a display to show successive frames of a main presentation and to intermittently display a predetermined map of indicia between the frames of the main presentation, whereby a device can determine its location.

This invention relates to controllers for displays.

### BACKGROUND OF THE INVENTION

There are multiple ways to film a subject in front of an artificially created background. One approach is to film the subject in front of a green screen and process the captured video at a later stage to impose certain background effects behind the subject. Another approach which uses less processing after capture is to use a display wall behind the subject which can be manipulated to show the desired scene. In the latter situation, if the filming camera moves around the studio, for example to zoom in on the subject or film them from another angle, the background scene must change accordingly so that the display appears real to the observers behind the camera. For example, the background scene may be manipulated to give the illusion of depth using motion parallax modelling. To be able to convincingly manipulate the image shown on the display, the relative position of the filming camera with respect to the display must be accurately and precisely known. For more advanced manipulation, the orientation of the camera (e.g., forward/back, up/down, left/right, yaw, pitch, roll) must also be accurately and precisely known. This location information is then fed back to a computer which is able to manipulate the background scene accordingly. Therefore, there exists a need to accurately and precisely determine the position and orientation of the filming camera.

One method to determine the location of the video camera is to use an optical tracking system. Optical reflective markers are positioned around a filming studio, for example on the ceiling, so that they are out of sight of the filming camera. The markers are randomly positioned in an irregular pattern across the studio. A second device comprising a camera is positioned on top or next to the filming camera and is directed towards the wall or ceiling with the markers. As the video camera moves around the studio, so does the second device. The images captured by the second device show the markers from different perspectives as it moves around. The images captured by the second device are processed to determine the location of the second camera. A processor may be within the second device or may be externally processed. This can be done in multiple ways, such as with a positioning algorithm (e.g., SLAM).

It may be inconvenient or impractical to position optical markers around a studio such as on the ceiling. It may also be difficult to place the markers out of sight of the filming camera. Difficulties also arise in situations where a studio with a ceiling or further wall is not available or practical, such as when filming outside.

There is a need for an improved method for locating an object, e.g., a video camera in an outdoor studio.

### SUMMARY OF THE INVENTION

According to the present invention there is provided a display controller configured to control frames shown on a display being imaged by a locating device and a camera, the display controller being further configured to cause the display to show successive frames of a main presentation and to intermittently display a predetermined map of indicia between the frames of the main presentation such that the map of indicia is imaged by the locating device but not the camera, and the locating device can determine its location in response to imaging the map of indicia.

The indicia may be star shaped. The indicia may vary in size across the map. The indicia may be a predetermined colour. Each indicium may be unique compared to all the surrounding indicia. The indicia may be arranged in a random or pseudo-random pattern. The shape, colour, size, and position of the indicia may contribute to the effectiveness of the map in allowing a device to determine its location.

The display controller may be configured to cause the display to reduce the intensity of the main presentation when the frames of the map of indicia are displayed, relative to the intensity of the main presentation during the frames of the main presentation which are shown between frames of the indicia. This may allow the indicia to be more easily picked up by a locating device as there might be greater contrast between the faded main presentation and the indicia.

The display controller may be configured to cause the display to maintain the intensity of the main presentation above zero when the frames of the map of indicia are displayed. This may reduce any flashing effects from rapidly changing the display.

The display controller may be configured to cause the display to selectively reduce the intensity of parts of the main presentation in the penumbra of each indicium when the frames of the map of indicia are displayed. This may increase the contrast between the background and the indicia which may allow for clearer imaging, whilst also possibly reducing the proportion of the background that changes in intensity during the frames of the indicia.

The display controller may be configured to cause the display to selectively change the colour of parts of the main presentation to a predetermined colour in the penumbra of each indicium when the frames of the map of indicia are displayed. This may increase the contrast between the background and the indicia which may allow for clearer imaging, whilst also possibly reducing the proportion of the background which must change in colour during the frames of the indicia.

The display controller may be configured to receive from the locating device an indication of the region of the display being currently imaged by the locating device. The display controller may then cause the display to show the section of the map of indicia corresponding to the region of the display currently being imaged by the locating device and not to show the indicia on sections of the display not currently being imaged by the locating device. This may prevent any unnecessary display of indicia and may reduce the proportion of the display showing the indicia during each frame.

The display controller may be configured to vary the number of frames of the main presentation shown between the frames of the map of indicia. This may allow for greater flexibility when using the display controller.

The display controller may be configured to receive data from the locating device. The display controller may be configured to vary the number of frames of the main presentation shown between the frames of the map of indicia depending on data received from the locating device. This may allow for more suitable and effective use of the display.

The display controller may be configured to vary the duration for which the display shows each frame of the map of indicia between the frames of the main presentation. This may allow for greater flexibility when using the display controller.

The display may extend spatially over a display surface comprising a plurality of display panels. A device may learn the geometry of the display. This may reduce the need for manually entered dimensions and may increase the ease-of-use of the display controller and connected devices.

There may be provided a system comprising a display controller and a camera. The camera may be directed at the display configured by the display controller. The frames of the camera may be in phase with the frames of the main presentation and may be out of phase with the frames of the map of indicia.

The system may comprise a locating device. The locating device may be directed at the display configured by the display controller. The frames of the locating device may be in phase with the frames of the map of indicia.

The system may comprise a synchronising device. The synchronising device may synchronise the camera, the locating device, and the display controller, such that the frames of the camera are in phase with the frames of the main presentation and are out of phase with the frames of the map of indicia, and such that the frames of the locating device are in phase with the frames of the map of indicia. This may allow the indicia to be intermittently displayed on the display wall without adversely affecting the images captured by the video camera. The map of indicia may be displayed in phase with the frames of the locating device so that the locating device can image the map and use it to determine its location.

The system may comprise a rendering computer. The rendering computer may be configured to send information to the display controller relating to the main presentation and to the map of indicia such that the display controller may be configured to cause the display to show successive frames of the main presentation and to intermittently display the predetermined map of indicia between the frames of the main presentation.

The system may comprise a rendering computer and a receiving card. The rendering computer may be configured to send a preliminary signal to the receiving card containing information relating to the map of indicia. This may be sent alongside other signals sent to the display controller such as the main presentation signal. The receiving card may be configured to store the information relating to the map of indicia. Once the first signal relating to the map of indicia has been received by the receiving card, the rendering computer may send information relating to the main presentation to the display controller. The rendering computer may no longer be required to send the map of indicia to the display controller. The rendering computer may send information to the display controller relating to the main presentation without the information relating to the map of indicia. This may reduce the amount of data that needs to be transferred from the rendering PC to the display controller.

The system may comprise a map inserter and a rendering computer. The map inserter may be configured to receive signals from the rendering computer relating to the main presentation and to receive signals from the synchronising device. The map inserter may output a signal to the display controller containing the input from the rendering computer combined with information relating to the map of indicia, such that the display controller may be configured to cause a display to show successive frames of the main presentation in sync with the camera and intermittently display the predetermined map of indicia between the frames of the main presentation in sync with the locating device. This may allow users to incorporate the map of indicia into their existing systems without needing to change the output of the rendering PC. It may also reduce the load on the rendering PC, as the rendering PC may not have to send information relating to the indicia whilst also rendering an image of the main presentation.

The map inserter may store multiple randomly or pseudo-randomly generated maps. The map inserter may be configured to generate random or pseudo-random maps of indicia. The map inserter may store a predetermined set of randomly or pseudo-randomly generated maps. Each map may be linked to a corresponding attribute that makes it suitable for a certain type of display wall or image. This may give the map inserter greater flexibility to be used in different scenarios with display walls of varying specifications.

The map inserter may be configured to receive data from the locating device. The map inserter may be configured to alter the output signal depending on data from the locating device. This may allow the map inserter to adjust the region of the display wall showing the indicia depending on the region of the display wall currently being imaged by the locating device. This may prevent any unnecessary display of indicia and may reduce the proportion of the display showing the indicia at any one time.

### BRIEF DESCRIPTION OF THE DRAWINGS

The present invention will now be described by way of example with reference to the accompanying drawings.

In the drawings:

FIG. 1 shows a studio with a display wall and display controller, a video camera, a locating device, a synchronising box and a rendering computer.

FIG. 2 shows a map of indicia on a display wall.

FIG. 3 shows an example of a synchronised system.

FIG. 4 shows an example of a map of indicia.

FIGS. 5a-5d show examples of how the display wall may be configured to display the map of indicia.

FIG. 6 shows a flow diagram showing how the rendering PC interacts with the display controller.

FIG. 7 shows an embodiment of the invention with a map inserter.

The discussion below will refer to mechanisms for estimating the position and orientation of objects. For conciseness only position will be referred to below, but it should be understood that orientation can be obtained at the same time.

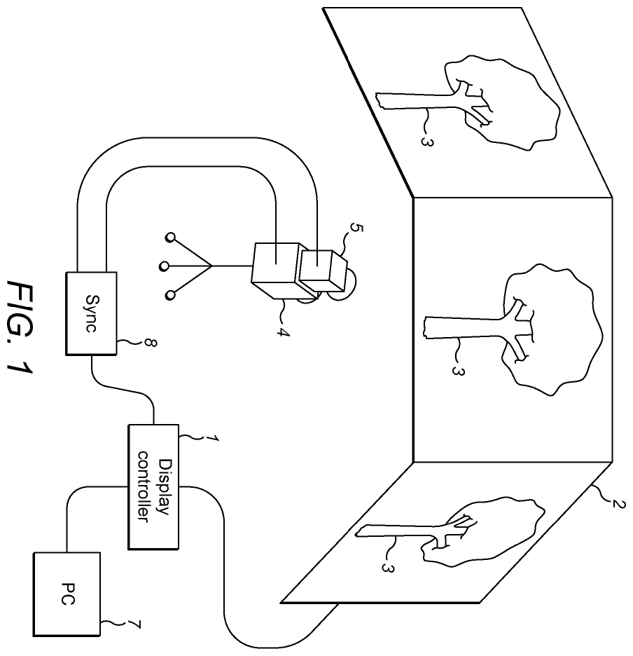

FIG. 1 shows a studio with a display wall 2, showing a main presentation, 3. The studio may be outdoors or in a venue without a ceiling or surrounding wall. The display wall may comprise a multitude of individual LEDs. The display wall may comprise one or more display panels. In FIG. 1 the display wall 2 is shown with three panels. The display panels may be arranged in any configuration. For example, a display panel may function as a ceiling for the surrounding display panels. A display controller, 1, is configured to cause the display wall to show the main presentation, 3. The main presentation represents the artificial background which may require distortion or manipulation when the video camera moves. For example, the main presentation may be a live-stream video feed from a remote camera capturing a crowd at Wimbledon.

The main presentation 3 is displayed on the display panels 2 in successive frames of still images which are displayed at a certain frequency, for example at 60 Hz.

A video camera, 4, films the display wall 2. The video camera 4 may move around in the space in front of the display wall, for example, the video camera may be hand-held or attached to a crane. The video camera 4 also captures the display in frames. The video camera may capture images or frames at a rate of 30 frames per second, for example. There is a gap between every frame when the video camera does not capture the image on the display. In these recurring gaps between the frames captured by the video camera, images shown on the display wall will not be recorded by the video camera.

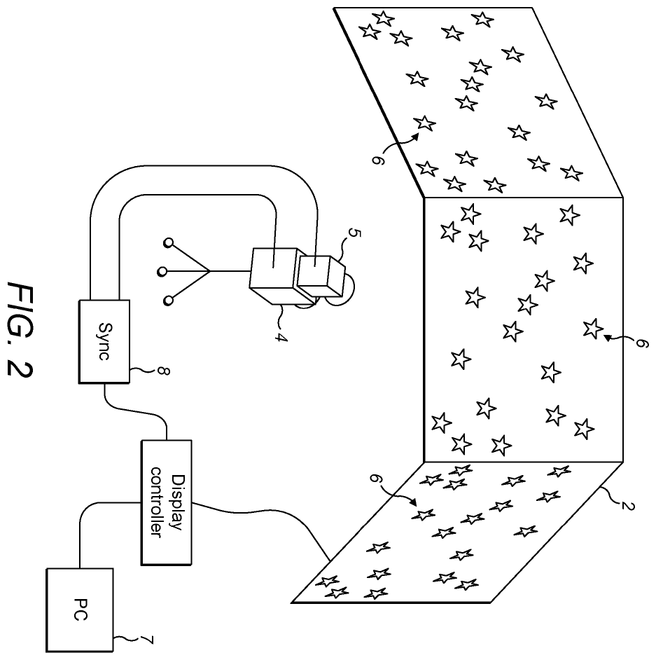

A locating device, 5, is attached to the video camera 4 such that the locating device 5 moves with the video camera 4. The locating device comprises a camera. The locating device may be a StarTracker apparatus as is commercially available from Mo-Sys Engineering Ltd. The locating device 5 may be synced to capture images of the display wall when the video camera 4 is not capturing images of the display wall. In some of these interstitial frames when the video camera is not capturing images, a predetermined map of indicia, 6, may be shown on part or all of the display wall 2. FIG. 2 shows an example of how the display wall 2 may appear to the locating device 5 during an interstitial frame of the video camera 4. The map of indicia 6 will be captured by the second device 5 if the second device has been synced to capture images at the same time as the display wall 2 shows frames of the map of indicia. In this way, a map of indicia 6 may be intermittently shown on the display between successive frames of the main presentation 3 and the map of indicia will not be captured by the video camera 4. Preferably the map of indicia 6 is only displayed during times when the video camera 4 is not capturing images.

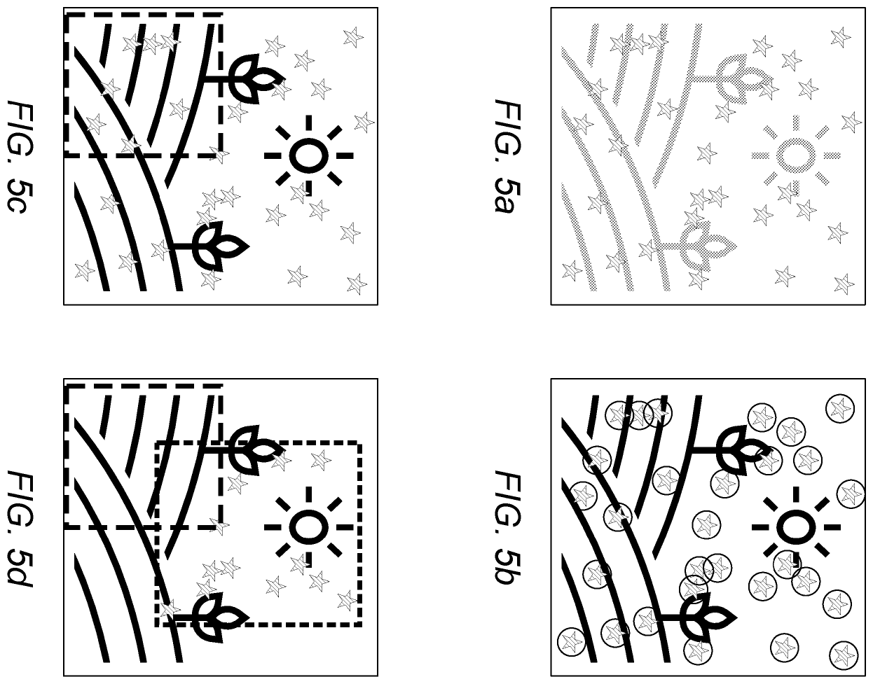

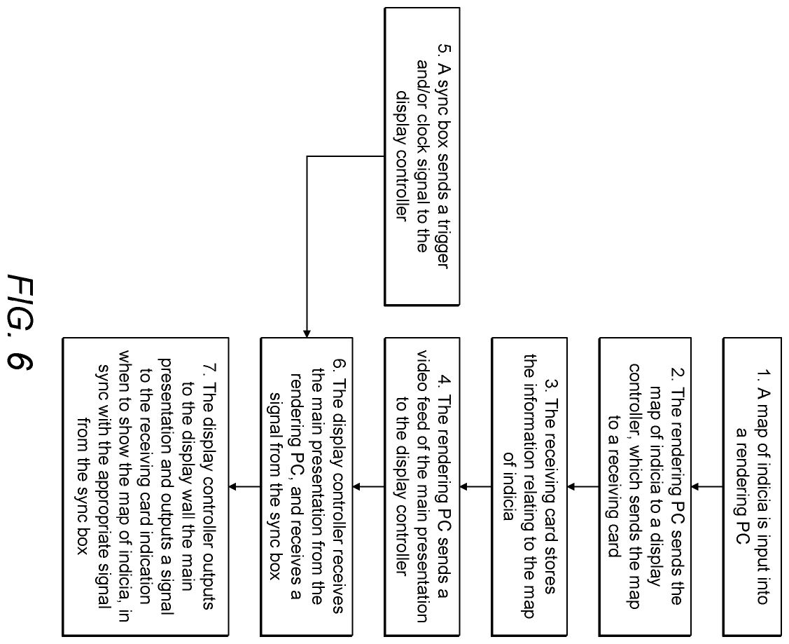

In an embodiment, the locating device 5 may be integral with the video camera 4. They may share the same camera to capture images of the display wall 2. In this embodiment, the shared video camera captures images at twice the rate compared to the frame rate of the video camera 4 of the previous embodiment. The shared video camera captures both the indicia 6 and the main presentation 3. The frames of the indicia 6 may then be separated from the frames of the main presentation 3, for example by an internal or external processor or rendering PC. This may be done by comparing the timing of each captured frame with the display controller timings for showing the indicia or the main presentation. A sync box 8 as described below may allow the processor to separate the captured images into the map and main presentation using the clock signal set by the sync box. Alternatively, the processor or rendering PC may be able to distinguish between the main presentation and the map of indicia through other means. The frames of the indicia and the main presentation may then be separately processed the same way in which they would be processed if they were separate devices. Further reference to a locating device 5 may include the situation where the locating device is built-in or incorporated into the video camera 4 with a shared camera if practically feasible (for example, FIGS. 5c-5d are not compatible with a shared camera setup)

Returning to FIG. 1, the display controller 1 is configured to cause the display wall 2 to show successive frames of the main presentation, 3. In some embodiments the display controller 1 may be connected directly to one or more displays. In other embodiments the display controller may be connected to a rendering computer, 7. The rendering PC 7 provides the video signal of the main presentation 3 and sends it to the display controller 1. The rendering PC 7 may also send signals to the display controller 1 relating to the predetermined map of indicia, 6. The video camera 4, the locating device 5 and the display controller 1 are connected to a sync box, 8. The rendering PC may also be connected to the sync box 8. The sync box coordinates the timings of the frames shown on the display wall by the display controller with the video camera 4 and the locating device 5. The sync box 8 is arranged so that the video camera captures the main presentation 3 and not the map of indicia, 6. The sync box is arranged so that the locating device captures the map of indicia, 6. Optionally, the locating device 5 may also capture images of the main presentation 3. The sync box acts as a central clock for the devices connected to it. The sync box may be run by the genlock system and/or may be a genlock controller. The sync box may use a signal from any of the devices to which it is connected to operate as a master clock signal. For example, the sync box may use an output from the video camera to operate as the master clock signal. Alternatively, the sync box may coordinate the connected devices using its own master clock signal.

FIG. 3 shows an illustrative example of how the sync box 8 may function. The main display shows either the main presentation 3, represented by “M”, or the map of indicia 6, represented by “I”. For simplicity, FIG. 3 shows only the situation where the display wall 2 is showing alternate frames of the main presentation 3 and the map of indicia 6. The display wall 2 is not limited to this pattern. The pulses of each square wave correspond to when the video camera 4 and locating device 5 respectively capture a frame. The pulse width of the square wave varies depending on the time it takes the camera to capture the image. The widths shown in FIG. 3 are for illustration purposes only.

The main presentation “M” and the map of indicia “I” may not be displayed for the entire duration between clock triggers as shown in FIG. 3. The display controller 1 may cause the display to only show the main presentation (“M”) or the indicia (“I”) during the frame capture period for the respective cameras, corresponding to the widths of the pulses in FIG. 3. The display may be black for the remaining time between pulses. Alternatively, the indicia may be shown only during the period when the locating device captures an image, and for the remaining time the main presentation could be displayed (even when the video camera is not capturing images). Displaying the indicia for the shortest time necessary may help reduce the visibility of the map of indicia to the human eye.

The sync box 8 may use a trigger to signal to the display controller 1 to change between the main presentation 3 and the map of indicia 6. The video camera may be programmed to capture images on the trigger of 1 or 0. The locating device may be programmed to capture images on the alternating trigger to the one used to trigger the video camera. Alternatively, instead of using a trigger, the video camera and locating device may look for a change in the clock signal as it goes from 1 to 0, for example. As mentioned above, the sync box 8 may use its own clock as the master clock to set the reference point for the connected devices. Alternatively, the sync box may use an output signal from one of the connected devices such as the video camera to act as the master clock which sets the reference point for the remaining connected devices.

The frames showing the main presentation 3, represented by “M” in FIG. 3, are in phase with when the video camera 4 captures frames. Frames or events may be in phase when they occur at at least partially overlapping times, and with substantially the same frequency or period. Frames or events may be out of phase when they occur at non-overlapping times, and with substantially the same frequency or period. The main presentation “M” is illustrated in FIG. 3 as in phase with the frames of the video camera by the pulse of the video camera square wave occurring during the period where the display shows “M”. This means that the video camera captures an image when the display wall is showing the main presentation. The frames of the video camera are out of phase with the frames showing the map of indicia. This is illustrated in FIG. 3 by the amplitude of the video camera square wave equaling zero during the periods where the display shows “I”. The period of the video camera square wave is greater than the duration for which the indicia are displayed per frame. This means that the video camera never captures an image when the display is showing the frames of the indicia.

The frames of the map of indicia 6 are in phase with the frames of the locating device 5. They are also out of phase with the frames showing the main presentation. This is illustrated in FIG. 3 by the pulse of the locating device square wave occurring during the period where the display shows “I”. This means that the locating device captures an image when the display is showing the map of indicia. In one embodiment, a frame of indicia is displayed between each frame of the main presentation. In another embodiment a frame of indicia is displayed less frequently than between every frame of the main presentation. For example, it may be displayed between every 3, 4 or 5 frames of the main presentation. This may reduce the processing load on the system and/or reduce any interference of the main presentation by frames of indicia. Irrespective of how frequently the frame of indicia is displayed, the locating device need not capture every displayed frame of indicia. It could capture only a subset of the frames of indicia. This may reduce the processing load of the locating device.

FIG. 3 demonstrates one example of how the sync box 8 may work. The frames of the display are not limited to the specific pattern shown in FIG. 3. For example, it may not always be the case that the map of indicia 6 is shown between every frame of the main presentation 3. It may only be necessary to display the indicia every 3 frames of the main presentation, for example. In this situation, the locating device 5 may capture a frame every 3 frames of the main presentation. Alternatively, the locating device may continue to capture images between frames of the video camera 4 but only use the frames showing the indicia to determine the location. The rendering PC 7 may be able to disregard images taken by the locating device that show the main presentation without any indicia. It may be necessary to vary the number of frames of the main presentation shown between frames of the map of indicia. The display controller 1 may be configured to vary the number of frames of the main presentation shown between frames of the map of indicia. The number of frames between the map of indicia may be user-programmable, or it may be dependent on data from other devices as explained below.

Optionally, the video camera 4 could run at double the frequency of the main presentation frame rate so that the video camera captures both the indicia and the main presentation. This may be useful if images shown during the indicia frames “I” could be used to aid post-production, for example. Alternatively, there may be further information that would be useful to show intermittently between the main presentation frames which could be incorporated into the indicia frames “I” and used in post-production. For example, an outline of where an object may later be added during post-production could be included during the frames of indicia if it can be of use for the actors or film crew.

The display controller 1 may be connected to the locating device 5 such that the display controller 1 receives information about the accuracy of the location data from the locating device 5. The locating device may contain sensors such as an accelerometer or a gyroscope. The accuracy of the determined position of the locating device may be dependent on the velocity and displacement of the video camera 4 and consequently the locating device. The display controller may receive data relating to the velocity and displacement of the video camera and locating device. Alternatively, it may receive data relating to the accuracy of the determined position of the locating device. The display controller may be configured to alter the display wall 2 depending on the data received from the locating device. For example, if the video camera 4 is stationary, then the locating device 5 is also stationary, so the position of the locating device will be more accurately known. The display controller may receive data from the locating device indicating a high level of position accuracy. In response to this information, the display controller 1 may cause the display wall 2 to show the map of indicia less frequently between frames of the main presentation.

Images captured by the locating device during the frames of the indicia allow the rendering PC to determine the position of the locating device at the time of the captured image of the map. However, the video camera may continue to move during the frames of the main presentation, in which case the location of the video camera determined from the previous image of the indicia will no longer be as accurate. Data from the sensors in the locating device may be used to determine a more accurate position of the video camera in the frames where the locating device is not capturing the indicia. The trajectory of the locating device (and consequently the video camera) may be predicted or interpolated from the location data gathered during the frames of the indicia. This may be done using sensor fusion techniques such as Kalman filters. This can be used to predict where the video camera will be during the frames of the main presentation.

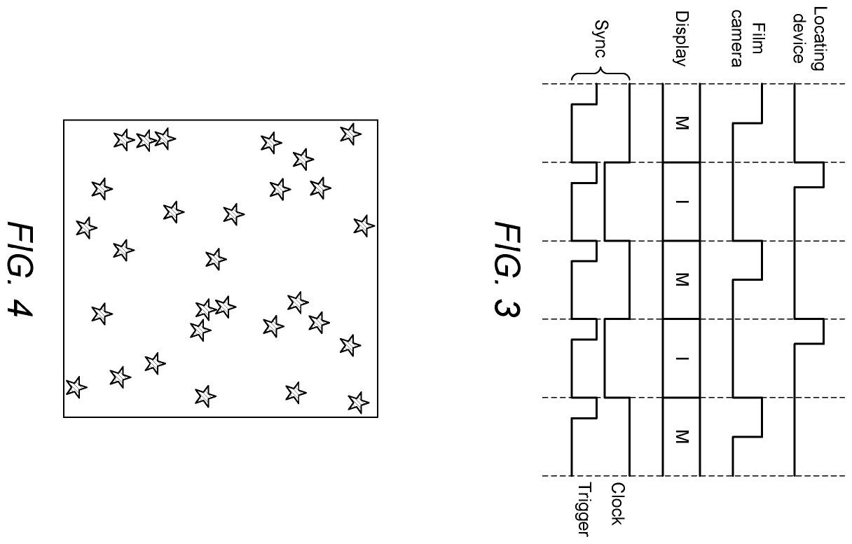

FIG. 4 shows an example of a map of indicia. The map of indicia, 6, may be predetermined. The advantage of using a predetermined pattern or map is that the locating device does not need to learn the in-panel position of each indicium before it can use the map to determine its location. However, it may be the case that the 2D positions of each indicium in the map is initially unknown to the locating device, in which case the locating device may learn the position of the indicia via a mapping process such as Structure from Motion (SfM). The indicia may be randomly positioned in a pattern or map. The indicia may be identical markers, such as only stars. The map may comprise of different types of markers such as stars, crosses, and dots. Each indicium could vary in size to the next. Each indicium in the map could be unique to all the surrounding indicia. For example, each indicium may be a unique QR code. The colour of the display around the indicia may be any colour, for example green to aid post-processing. The colour of the display may contrast the colour of the indicia, so that the map is more easily distinguished in the captured images. The map of indicia may be generated specifically for capture by the StarTracker apparatus, as is commercially available from Mo-Sys Engineering Ltd. Using a StarTracker-specific map of indicia with the StarTracker locating device may increase the efficiency of the location determining process.

In addition to the 2D in-panel position of each indicium in the map, the 3D coordinates of the indicia relative to each other across the display panels may be unknown. The display wall 2 may extend spatially over a display surface. For example, the display wall may comprise several display panels positioned at varying angles relative to each other. The display wall may have irregular geometry. Therefore, the 3D position of the indicia relative to each other may need to be determined. The locating device may send images to the rendering PC of the predetermined map of indicia when displayed on the display surface. The rendering PC may learn the geometry of the display surface by using the images of the indicia taken by the locating device and a mapping process such as SLAM. Alternatively, the locating device itself may process the captured images to learn the geometry of the display surface and send the learned information back to the rendering PC. Thus, the 3D position of each indicium relative to the others may be determined. This removes the need for the dimensions of the display wall to be manually entered into the rendering PC which increases the efficiency and ease of the initial studio set-up and reduces the chance for human error.

It may be advantageous to vary the way in which the map of indicia is displayed between frames of the video camera, for example by selectively displaying the map of indicia on a particular area of the display wall. It may also be advantageous to reduce any unnecessary display of indicia, for example to reduce the possible visibility of the map of indicia to the human eye. Subjects in the studio such as the actors and cameramen may be able to perceive flashing effects from the rapid changes in the images displayed on the wall. Although the map of indicia may not be visible to the human eye because it is present for too short an amount of time, there may be some discomfort caused subconsciously by the flashing images. There may be more serious consequences for sufferers of epilepsy, for example. Despite the video camera operating at a different time to the frames of the indicia, there may be some unwanted residual effects of rapidly changing the images on the display wall between frames. It may be advantageous to show the map of indicia less frequently than between every frame of the main presentation, and/or out of the frustum or field of view of the video camera since that may reduce interference on the video camera's capturing of the main presentation.

To improve the versatility of the invention and reduce any possible side effects, the following optional features may be implemented.

FIG. 5a shows the main presentation at a reduced intensity when the map of indicia is also being displayed. The main presentation is represented by the image of the hill and the sun. The main presentation may be copied from the previous main presentation frame (“M”) by the display controller so that the load on the rendering PC is reduced between frames of the main presentation. Showing the indicia, or the indicia overlayed with a copied image of the previous “M” frame, between main presentation frames gives the rendering PC more time to prepare the next adjusted frame of the main presentation. The indicia are represented by stars in FIG. 5a but are in no way limited to this format. The display controller may be configured to cause the display wall to reduce the intensity of the main presentation when the display wall shows the frames of the map of indicia. The display wall may maintain the intensity of the main presentation above zero during the frames of the map of indicia. Reducing the intensity of the main presentation whilst keeping it above zero during the frames of the map of indicia may reduce the flashing effect of rapidly changing the display. The intensity of the main presentation may be reduced by the minimum amount necessary for the indicia to be processed by the rendering PC using the images captured by the locating device. This may depend on how accurately the position of the locating device is known. For example, if the video camera is stationary, the indicia may be displayed more faintly as they are not as required to determine the location compared to when the video camera is moving around. Any further reduction in the intensity of the main presentation is unnecessary if the images captured by the locating device can still be used by the rendering PC to determine the position of the locating device.

The display controller may be configured to cause the display to alter the main presentation in the penumbral region around the indicia when the display shows the frames of the map of indicia. The circular regions shown in FIG. 5b encompass an indicium each and represent the respective penumbral region for each indicium. The main presentation within that region may have a reduced intensity or may change colour. This is not shown in FIG. 5b. The penumbral region can be user programmed to cover a certain area surrounding each indicum. For example, the penumbral region may be the area immediately surrounding each indicium within a 30 cm radius of the centre of each indicium. Alternatively, the penumbral region may be defined as the area immediately surrounding each indicium with a radius of 10 times the radius of the respective indicium. If, for example, the indicia are not equal sizes, the penumbral region may vary depending on the radius of the indicium which it surrounds. Alternatively, the penumbral region may be a fixed area surrounding each indicium, for example, a circle of radius 30 cm, 40 cm, or 60 cm. The alteration in the penumbral region may relate to intensity or colour, for example. The penumbral region may change colour (including the colour black when the LEDs are switched off) or intensity to increase the contrast between the indicium and the main presentation so that it is easier for the indicium to be picked up by locating device.

The situation may arise where the video camera is focused on a particular sub-section of the display wall for a certain period of time. FIG. 5c shows the region of the display being imaged by the video camera with the dashed square. It would be advantageous to display the map of indicia in the regions of the display wall which are out of the sight of the video camera so that any possible detection of the indicia by the video camera is completely avoided. The display controller may be configured to receive information from the video camera indicating the region of the display which is currently being imaged by the video camera. The display controller may then cause the display to show the map of indicia on regions of the display which are outside the field of view of the video camera as indicated by the received data.

There may be situations where the locating device does not image all of the display wall at any one time. For example, in the situation where the display wall consists of a main panel and two sides panels, the locating device may not be able to image all three sides simultaneously. FIG. 5d shows a simplified example of a section of the display wall being imaged by the locating device, represented by the dotted square. There would be no benefit to displaying indicia on sections of the wall which are not being imaged by the locating device. The display controller may be configured to receive information from the locating device indicating the region of the display which is currently being imaged by the locating device. The display controller may then cause the display wall to show the indicia on the region of the display currently being imaged by the locating device, and to not show the indicia on the remaining sections of the display wall which are not being imaged by the locating device. This allows for more efficient use of the display wall.

FIG. 5d shows a situation where there are two overlapping regions of the display wall being imaged by the video camera and the locating device. The effects mentioned above may apply in any working combination. For example, if the region being imaged by the video camera exactly overlaps with the region being imaged by the locating device, then the above technique relating to imaging regions cannot be applied. Instead, the display controller may cause the display to alter the main presentation in the penumbral regions of the map of indicia in the region being imaged by both cameras. The display controller may employ the above techniques in any combination depending on the position and regions imaged by the two cameras to allow for versatile and effective use of the display wall.

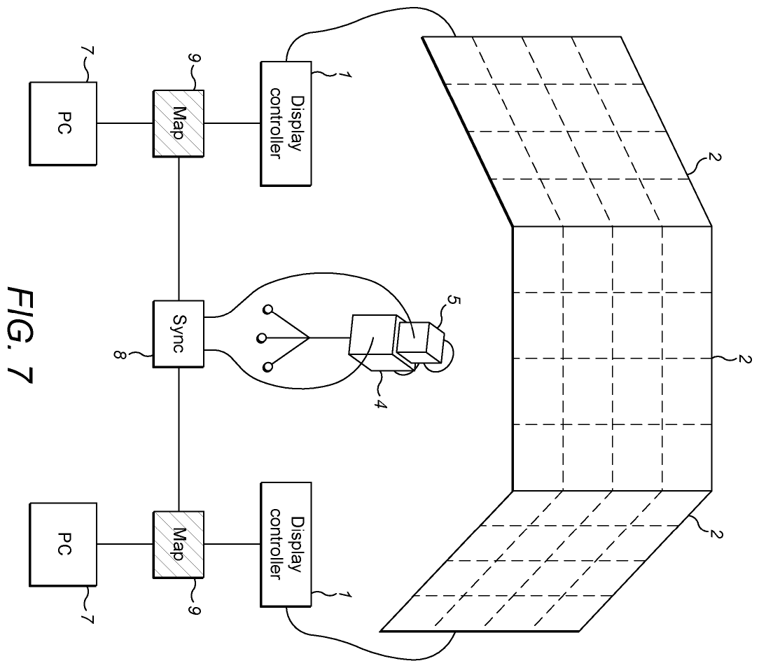

In some embodiments, a rendering PC provides the signal for both the main presentation and for the map of indicia. However, unlike the main presentation, the map of indicia does not require constant manipulation or alteration. Therefore, the map image data does not need to be transmitted from the rendering PC every time it is needed. To reduce the amount of data being transferred, a receiving card may store the map of indicia once initially received. Following a signal from the rendering PC or display controller, the receiving card can then display the map of indicia without needing to receive the whole image data first. FIG. 6 shows an example of how the display controller may interact with a rendering PC, a receiving card, and a sync box. The rendering PC may send an initial signal to the receiving card in the display wall relating to the map of indicia. The receiving card may store this map. Future signals from the rendering PC may no longer need to include the map of indicia. The display controller may transmit a signal to the receiving card which results in the receiving card displaying the map of indicia. The benefit of having the map stored on the receiving card is that much less data needs to be transmitted from the rendering PC to the display controller.

As mentioned already, the display controller may receive data from either or both of the locating device and the video camera. The flow diagram as shown in FIG. 6 may include a further step at step 6. At step 6, the display controller may receive data from the locating device and/or the video camera. The data from the locating device may relate to the accuracy of the determined position of the video camera, or to the region of the display currently being imaged by the locating device, or to both. The display controller may output a signal to the receiving card indicating when or where to display the map of indicia which is dependent on the data received from the locating device.

The data from the video camera may relate to the region of the display currently being imaged by the video camera. The display controller may output a signal to the receiving card indicating where and/or when to display the indicia which is dependent on the data received from the video camera.

The display controller may transmit a signal to the receiving card which is a function of both received data from the locating device and the video camera.

In another aspect of the invention, the rendering PC does not send information relating to both the main presentation and the map of indicia. Instead, a map inserter is connected between the rendering PC and the display controller. FIG. 7 shows a studio with two display controllers 1, a display wall 2, video camera 4, locating device 5, sync box 8, map inserters 9, and a rendering PC 7. The map inserter 9 may be connected between the rendering PC and the display controller and may have multiple inputs. The rendering PC no longer needs to send information relating to the map of indicia. This allows the system to be more easily implemented into existing studios and workflows. For example, users will be able to simply plug in the map inserter between the rendering PC and the display controller, as opposed to altering the output of the rendering PC. This set up also gives the rendering PC more time between main presentation frames to render the next image of the main presentation. This may have several advantages, such as allowing for a more detailed modified image to be displayed on the display wall, or for a slower rendering PC to be able to implement the changes within the time frame. The map inserter may store multiple maps of indicia. The map inserter may generate a map of indicia randomly or pseudo-randomly from a specified seed value. The map inserter may store multiple randomly or pseudo-randomly generated maps. A particular map could be selected from a pre-programmed set of randomly or pseudo-randomly generated maps which may satisfy specific criteria that make them suitable for different situations, for example there may be different maps for different display resolutions. The map inserter receives the video feed relating to the main presentation from the rendering PC. The map inserter also receives a clock signal or trigger signal from the sync box. The map inserter interweaves the main presentation signal with a signal relating to the map of indicia using the trigger or clock signal from the sync box. The map inserter outputs a signal to the display controller containing both the main presentation signal from the rendering PC and the signal relating to the map of indicia, such that the display controller may cause the display to show successive frames of the main presentation and intermittently show frames of the map of indicia.

The map inserter may perform any of the functions described above in relation to the display controller. The map inserter may be connected to the video camera and locating device. The map inserter may receive data from the locating device relating to the accuracy of the determined position of the locating device. The map inserter may receive data from the locating device relating to the region of the display wall currently being imaged by the locating device. Likewise, the map inserter may receive data from the video camera relating to the region of the display wall currently being imaged by the video camera. The map inserter may vary the interleaved signal outputted depending on the data received.

The system may have any convenient number of displays, display controllers, receiving cards and other components. They may be linked together and operate with each other in any convenient way. For example, the display wall may be made up of many individual smaller screens. The smaller screens may be grouped together with surrounding smaller screens so there are multiple groups per display wall. Each group may be connected to a receiving card. Multiple receiving cards may be connected to one display controller. There may be multiple display controllers for one display wall. There may be multiple rendering PCs for one display wall. A display controller for a display wall is described herein, however, the features of the display controller may apply to multiple screen controllers for the same display wall.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention.

1. A display controller configured to control frames shown on a display being imaged by a locating device and a camera, the display controller being further configured to cause a display to show successive frames of a main presentation and to intermittently display a predetermined map of indicia between the frames of the main presentation such that the map of indicia is imaged by the locating device but not the camera, and the locating device can determine its location in response to imaging the map of indicia.

2. A display controller as claimed in claim 1, the display controller being configured to cause the display to reduce the intensity of the main presentation when the frames of the map of indicia are displayed relative to the intensity of the main presentation during the frames of the main presentation which are shown between frames of the indicia.

3. A display controller as claimed in claim 2, the display controller being configured to cause the display to maintain the intensity of the main presentation above zero when the frames of the map of indicia are displayed.

4. A display controller as claimed in claim 2, the display controller being configured to cause the display to selectively reduce the intensity of parts of the main presentation in the penumbra of each indicium when the frames of the map of indicia are displayed.

5. A display controller as claimed in claim 1, the display controller being configured to cause the display to selectively change the colour of parts of the main presentation to a predetermined colour in the penumbra of each indicium when the frames of the map of indicia are displayed.

6. A display controller as claimed in claim 1, the display controller being configured to receive from the locating device an indication of the region of the display being currently imaged by the locating device, and to cause the display to show the section of the map of indicia corresponding to the region of the display currently being imaged by the locating device and not to show the indicia on sections of the display not currently being imaged by the locating device.

7. A display controller as claimed in claim 1, wherein the display controller is configured to vary the number of frames of the main presentation shown between the frames of the map of indicia.

8. A display controller as claimed in claim 1, wherein the display controller is configured to receive data from the locating device and to vary the number of frames of the main presentation shown between the frames of the map of indicia depending on data received from the locating device.

9. A display controller as claimed in claim 1, wherein the display controller is configured to vary the duration for which the display shows each frame of the map of indicia between the frames of the main presentation.

10. A display controller as claimed in claim 1, the display extending spatially over a display surface comprising a plurality of display panels, whereby a device can learn the geometry of the display.

11. A system comprising a display controller as claimed in claim 1 and a camera, wherein the camera is directed at the display configured by the display controller, and wherein the frames of the camera are in phase with the frames of the main presentation and are out of phase with the frames of the map of indicia.

12. A system as claimed in claim 11, wherein the system comprises a locating device, wherein the locating device is directed at the display configured by the display controller, wherein the frames of the locating device are in phase with the frames of the map of indicia.

13. A system as claimed in claim 11, wherein the system comprises a synchronising device, wherein the synchronising device synchronises the camera, the locating device, and the display controller, whereby the frames of the camera are in phase with the frames of the main presentation and are out of phase with the frames of the map of indicia, and the frames of the locating device are in phase with the frames of the map of indicia.

14. A system as claimed in claim 11, wherein the system comprises a rendering computer, wherein the rendering computer is configured to send information to the display controller relating to the main presentation and to the map of indicia, whereby the display controller is configured to cause the display to show successive frames of the main presentation and to intermittently display the predetermined map of indicia between the frames of the main presentation.

15. A system as claimed in claim 11, wherein the system comprises a rendering computer and a receiving card, wherein the rendering computer is configured to send a preliminary signal to the receiving card containing information relating to the map of indicia, and wherein the receiving card is configured to store the information relating to the map of indicia.

16. The system as claimed in claim 11, wherein the system comprises a map inserter and a rendering computer, wherein the map inserter is configured to receive signals from the rendering computer relating to the main presentation and to receive signals from the synchronising device, and to output a signal to the display controller containing the input from the rendering computer combined with information relating to the map of indicia, whereby the display controller is configured to cause a display to show successive frames of the main presentation in sync with the camera and intermittently display the predetermined map of indicia between the frames of the main presentation in sync with the locating device.

17. The system as claimed in claim 16, wherein the map inserter is configured to receive data from the locating device, and to alter the output signal depending on data from the locating device.
